(19) United States
(12) Patent Application Publication
(10) Pub. No.: US 2022/0043226 A1
(43) Pub. Date: Feb. 10, 2022

(54) PRECONNECTORIZED CABLE ASSEMBLIES FOR INDOOR/OUTDOOR/DATACENTER APPLICATIONS

(71) Applicant: Corning Research & Development Corporation, Corning, NY (US)

(72) Inventors: Scott Frederick Andrus, Corning, NY (US); Terry Lee Cooke, Hickory, NC (US); Michael Todd Faulkner, Granite Falls, NC (US); Lars Kristian Nielsen, Hickory, NC (US); Marcus Ray Sullivan, Hickory, NC (US); Wendell Porter Weeks, Corning, NY (US)

(21) Appl. No.: 17/497,129

(22) Filed: Oct. 8, 2021

Related U.S. Application Data
(63) Continuation of application No. PCT/US2020/028431, filed on Apr. 16, 2020.
(60) Provisional application No. 62/834,850, filed on Apr. 16, 2019.

(51) Int. Cl. G02B 6/44

(52) U.S. Cl. CPC G02B 6/4413; G02B 6/4404; G02B 6/4436

(57) ABSTRACT

A configurator design tool is provided to facilitate the manufacture of pre-configured multi-fiber optical cable and loaded optical fiber cable storage reels. The configurator design tool also facilitates the configuration of fiber-optic data centers or other types of fiber-optic infrastructure. The present disclosure also contemplates methodology for manufacturing pre-configured multi-fiber optical cable and loaded optical fiber cable storage reels, and for configuring fiber-optic data centers or other types of fiber-optic infrastructure. Additional embodiments relate to contemplated pre-configured multi-fiber optical cable loaded optical fiber cable storage reels, and to fiber-optic data centers or other types of fiber-optic infrastructures.

### CROSS-REFERENCED TO RELATED APPLICATIONS

This application is a continuation of International Patent Application No. PCT/US2020/028431 filed Apr. 16, 2020, which claims the benefit of priority under 35 U.S.C. § 119 of U.S. Provisional Application Ser. No. 62/834,850 filed on Apr. 16, 2019, the content of which is relied upon and incorporated herein by reference in its entirety.

### TECHNICAL FIELD

The present disclosure relates to pre-connectorized optical cable assemblies with features that provide ease of handling and increased installation speed as well as methods of manufacturing such cable assemblies. The present disclosure also relates to configurator design tools for pre-configuring multi-fiber optical cables, loaded optical fiber cable storage reels, and fiber-optical data centers and other types of fiber-optic infrastructures.

### BACKGROUND

Fiber optic cables are an attractive alternative to bulky traditional conductor cables (e.g., copper) in waveguide systems allowing for wide bandwidth data transmission while simultaneously transporting multiple signals and traffic types and/or high-speed Internet access, especially as data rates increase. Data centers, for example, utilize multi-fiber cables to interconnect and provide signals between building distribution frames and to individual unit centers, such as computer servers. However, the labor and cost of deployment of such multi-fiber cable networks for a data center tend to be high and time-consuming.

Data center design and cabling-infrastructure architecture have evolved over the years as needs and technologies have changed. Planning for today's complex, often large, data centers and/or other optical networks requires tools and capabilities that account for increased optical fiber densities and constant expandability. The most efficient optical infrastructure is one in which as much as possible the infrastructure components are preterminated in the factory. The components may be preterminated in the factory with all connectors installed, tested and packaged for efficient, safe installation at the data center. The installer may then unpack the components, pull or route the preconnectorized cable assembly into place, snap in the connectors, install patch cords to end equipment if necessary, and the system is up and running.

In addition, to realize additional benefits associated with these novel plug-and-play, preterminated components in high density cable networks, less costly and time intensive tools and methodologies are needed for configuring and providing these pre-configured multifiber optical cables into the often complex fiber-optic infrastructure designs of today.

### SUMMARY

In accordance with aspects of the present disclosure, a cable access method is described as a means to facilitate the manufacture of a pre-configured multi-fiber optical cable. The present disclosure also contemplates methodology for manufacturing pre-configured multi-fiber optical cables.

In accordance with other aspects of the present disclosure, a configurator design tool is provided to facilitate the manufacture of complex, pre-configured, multi-fiber optical cable and loaded optical fiber cable storage reels. The configurator design tool also facilitates the configuration of fiber-optic data centers or other types of fiber-optic infrastructure.

Although the concepts of the present disclosure are described herein with primary reference to a data center, it is contemplated that the concepts will enjoy applicability to any outdoor and indoor waveguide system associated with digital infrastructure data including an infrastructure layout and housing server rack systems. For example, and not by way of limitation, it is contemplated that the concepts of the present disclosure will enjoy applicability to indoor warehouses or commercial buildings.

It is to be understood that both the foregoing general description and the following detailed description of the invention are intended to provide an overview or framework for understanding the nature and character of the invention as it is claimed.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically illustrates a data center topology, in accordance with aspects of the disclosure herein;

FIG. 2 schematically illustrates a large data center topology, in accordance with aspects of the disclosure herein;

FIG. 3 schematically illustrates a spine and leaf switch architecture in relation to a data center topology, in accordance with aspects of the disclosure herein;

FIG. 4 schematically illustrates a view of another spine and leaf architecture in relation to a data center topology, in accordance with aspects of the disclosure herein;

FIG. 5 schematically illustrates another view of a portion of the data center of FIG. 1 with a distribution cable termination in the entrance room, in accordance with aspects of the disclosure herein;

FIG. 6 schematically illustrates another view of a portion of the data center of FIG. 1 with a distribution cable having subunits that extend directly to the MDA, in accordance with aspects of the disclosure herein;

FIG. 6A schematically illustrates the clutter of cables replaced by pre-engineered, preconfigured cables, in accordance with aspects of the present disclosure;

FIG. 7A schematically illustrates a type of ribbon cable for use in manufacturing a pre-configured multi-fiber optical cable, in accordance with aspects of the disclosure herein;

FIG. 7B schematically illustrates a generic subunit cable for use in manufacturing a pre-configured multi-fiber optical cable, in accordance with aspects of the disclosure herein;

FIG. 7C schematically illustrates a type of helical wound cable for use in manufacturing a pre-configured multi-fiber optical cable in accordance with aspects of the disclosure herein;

FIG. 8A is a perspective view of a section of fiber optic distribution cable, in accordance with aspects of the present disclosure;

FIG. 8B is a perspective view of a section of a subunit cable of the distribution cable of FIG. 8A, in accordance with aspects of the present disclosure;

FIG. 9A is a cross-sectional view of an embodiment of the distribution cable of FIGS. 8A-8B, in accordance with aspects of the present disclosure;

FIG. 9B is a cross-sectional view of another embodiment of the distribution cable of FIGS. 8A-8B, in accordance with aspects of the present disclosure;

FIG. 10A is a schematic view of an embodiment of a preconnectorized distribution cable assembly including the distribution cable of FIGS. 8A-9B and illustrating a distribution tether with MTP connectors and eight subunit cables with MTP connectors;

FIG. 10B is a schematic view of another embodiment of a preconnectorized distribution cable assembly including the distribution cable of FIGS. 8A-9B and illustrating a distribution tether with MTP connectors and eight tether subunits with LC uniboot connectors;

FIG. 10C is a schematic view of another embodiment of a preconnectorized distribution cable assembly including the distribution cable of FIGS. 8A-9B and illustrating multiple distribution tethers and multiple tap tethers;

FIG. 11 is a schematic view of equipment racks and distribution cables in a data center, in accordance with aspects of the present disclosure;

FIG. 12 illustrates a process flow for designing and manufacturing a pre-configured multi-fiber optical cable in accordance with aspects of the disclosure herein;

FIG. 13 illustrates a process flow for use of a configurator tool to create a design for a pre-configured multi-fiber optical cable, in accordance with aspects of the disclosure herein; and

FIG. 14 illustrates a computer implemented system for use with the process flows of FIG. 9 or FIG. 10, in accordance with aspects of the disclosure herein.

### DETAILED DESCRIPTION

Aspects of the disclosure herein describe pre-configured, multi-fiber optical cables and a design tool for pre-configuration of multi-fiber optical cables and components based on design requirements of a data center infrastructure or other optical cable network.

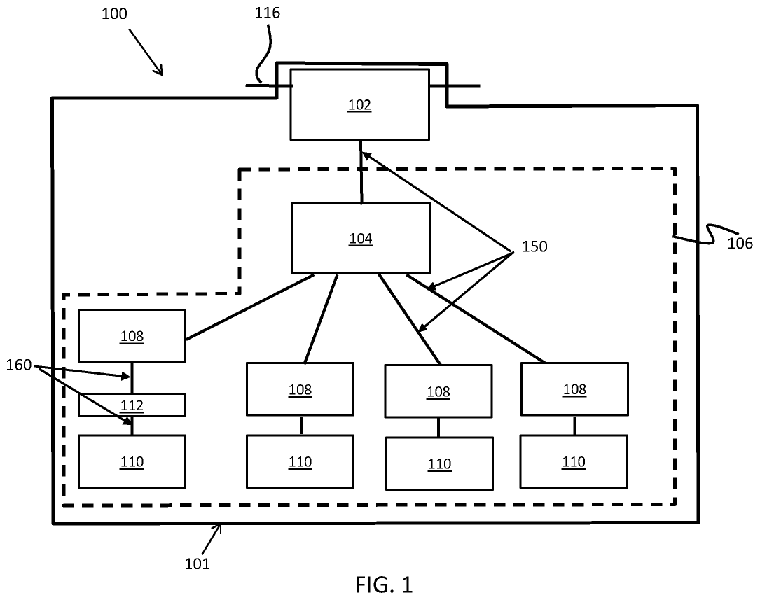

Referring to FIG. 1, the topology of an exemplary data center 100 is shown. The data center 100 conventionally comprises a set of spaces delineated by function which may be housed in a single building 101. For example, as shown in FIG. 1, the data center may include one or more entrance rooms 102 or entry points. The entrance room 102 is conventionally the space used for interfacing the structured cabling infrastructure of the data center 100 with inter-building cabling. Each entrance room 102 may be configured to act as a termination point for external optical connections to a wide area network (WAN) and/or other data center buildings 100. The data center 100 may optionally have multiple entry rooms 102 to provide redundancy or to avoid exceeding maximum cable lengths. The entrance room 102 may contain carrier equipment and serve as the demarcation between that carrier equipment and the data center.

The entrance room 102 communicates with a Main Distribution Area (MDA) 104. The MDA 104 may be separately contained in a dedicated computer room 106. In some cases, the entrance room 102 may be combined with the MDA 104. The MDA 104 is the central point of distribution for the data center structured cabling system. Core routers, core Local Area Network (LAN) switches, core Storage Area Network (SAN) switches, and Private Branch eXchange (PBX), among other components, may be located in the MDA 104. The MDA 104 may serve one or more Horizontal Distribution Areas (HDAs) 108 or Equipment Distribution Areas (EDAs) 110. The HDA 108 may include LAN switches, SAN switches, and Keyboard/Video/Mouse (KVM) switches for equipment located in the EDAs 110. In a small data center, the MDA 104 may serve the EDAs 110 directly with no HDAs 108. However, most data centers, particularly large data centers, will have multiple HDAs 108. The EDA 110 contains the end equipment, including computer systems and telecommunications equipment typically organized in racks or cabinets. In some cases, a Zone Distribution Area (ZDA) 112 may be provided between the HDA 108 and the EDA 110 to provide for frequent reconfiguration and flexibility.

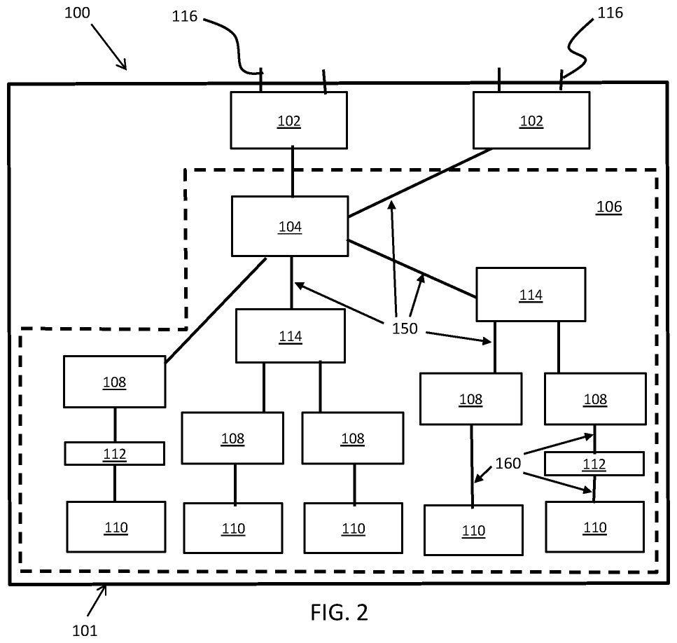

As shown in FIG. 2, for a very large data center 100, which may be located on multiple floors or in multiple rooms, in addition to the components and spaces described above, there may be a need for multiple entrance rooms 102 and/or Intermediate Distribution Areas (IDAs) 114 in between the MDA 104 and the HDAs 108.

The data center 100 works by interconnecting all of the computational, storage, and networking resources in each of the spaces outlined above in an efficient and scalable configuration. Data centers have conventionally been based on a three-tier data center network architecture comprising a hierarchical aggregation of switches at each tier. The lowest layer or access layer comprises the servers and computer equipment that are connected directly to access layer switches. An aggregate layer interconnects the access layer switches together and a core layer connects the aggregate layer switches while also connecting the data center to the internet, for example. Today's large data centers are based upon the same three-tier data center architecture, but the number of network switches is greatly expanded and the interconnectivity between the various tiers is greatly enhanced to reduce latency and provide redundant pathways for data to move. To help organize and design these complex networks, many data centers are organized in pods that use a spine and leaf topology to organize the equipment and switches in an efficiently functioning mesh.

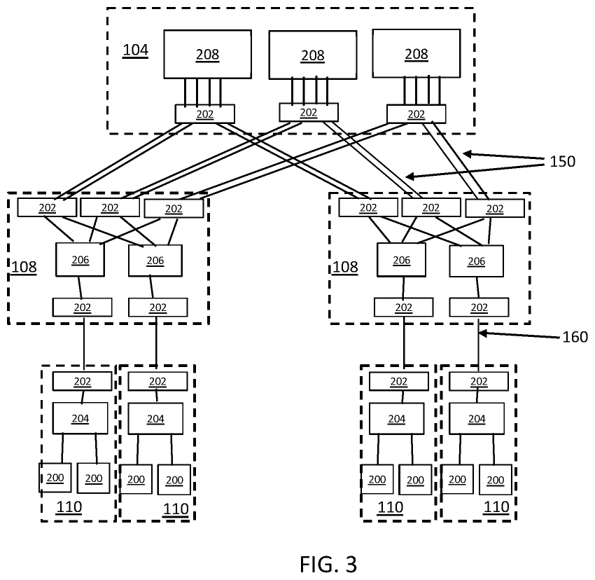

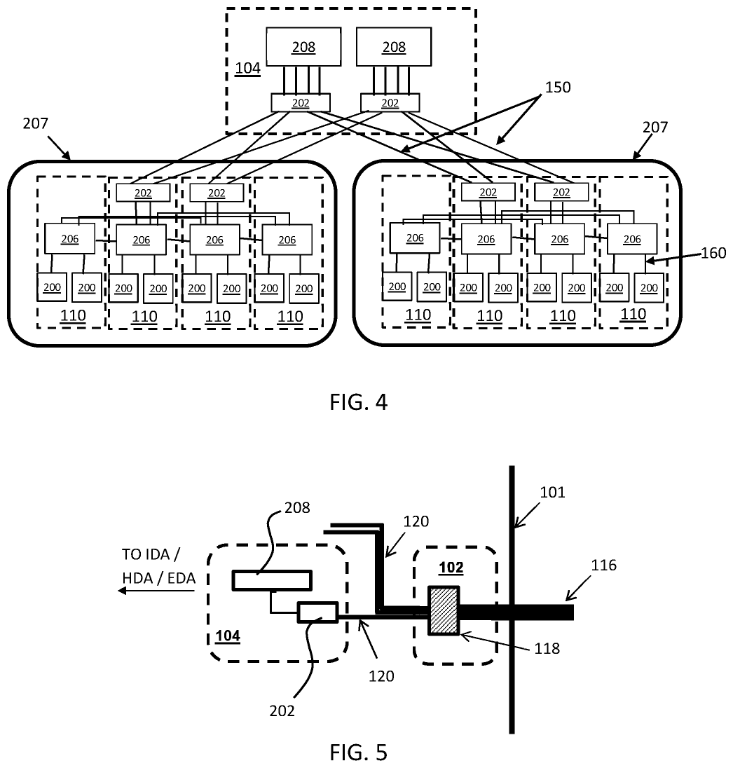

FIG. 3 illustrates a spine and leaf network architecture and where in the data center the particular components may be located. The servers 200 may be arranged in rows of cabinets in the EDA 110 and may be connected through patch panels 202 and/or port extenders 204 to the access (leaf) switches 206 in the HDA 108. All access switches 206 are in turn connected to every interconnection (spine) switch 208 in the MDA 108, and the connections may be made by way of patch panels 202. In accordance with other aspects of the present disclosure, and as shown in FIG. 4, the access switches 206 may be extended into the EDAs when arranged in pods 207 and/or as top of rack switches. The interconnection (spine) switches 208 may be located in one or more MDAs 104 and may or may not be connected to each other. In accordance with other aspects of the disclosure, the interconnection (spine) switches 208 may be located in an IDA 114 if the data center is organized into different areas to manage subsets of data, for example.

As shown in FIGS. 1-4, the cabling topology for a data center includes many different types of cabling, such as distribution cabling 116 coming into the data center and all the structured cabling to connect all of the switches and equipment internal to the data center. As illustrated in the figures, the data center structured cabling may be categorized as backbone cabling 150 and horizontal cabling 160. Backbone cabling 150 conventionally provides connections between the MDAs, IDAs, HDAs, telecommunications rooms, and entrance facilities in the data center cabling system. Backbone cabling 150 consists of backbone cables, such as indoor trunk cables, main cross-connects, intermediate cross-connects, horizontal cross-connects, mechanical terminations, and patch cord or jumpers used for backbone-to-backbone cross-connection. The backbone cabling 150 should accommodate data center growth and changes in service requirements without installation of additional cabling. The most efficient optical infrastructure is one in which all or most of the components are preterminated in the factory. All connectors are installed and tested in the factory and packaged such that components are not damaged during installation. The installer unpacks the components, pulls the preconnectorized cable assembly into place, snaps in all the connectors, and installs the patch cords if necessary connecting to the end equipment, and the system is up and running.

As shown in FIG. 5, for example, a high-fiber count (HFC) distribution cable 116 may be routed from an environment external to the data center building 101 and into the entrance room 102. To keep pace with the growing demands for data and processing, a single distribution cable 116 today may comprise thousands of optical fibers. These optical fibers are typically terminated at or near the entrance room 102 and have to be spliced into the backbone infrastructure of the data center. For example, as shown in FIG. 5, an optical splice enclosure 118 may be provided in the entrance room 102 for splicing, protecting and organizing groups of optical fibers or individual optical fibers contained in the distribution cable 116. Individual or multifiber pigtails 120 may be spliced to the distal ends of the optical fibers in the distribution cable 116. The other ends of the pigtails 120 may be connectorized and connect to a patch panel in the MDA 104. As described above, the patch panels may then in turn be connected to spine switches 208, or the pigtails 120 may be routed and connected directly to the spine switches 208 and/or other components or spaces in the data center.

It is contemplated that any conventional or yet-to-be developed optical connector or connectorization scheme may be used in accordance with the present disclosure, including, but not limited to, small (e.g., LC) and multi-fiber (e.g., MPO/MTP) connectors as commercially available. An LC connector may include a simplex design for a single optical fiber for transmission in a single direction (e.g., transmit or receive) or when a multiplex data signal is used for bi-directional communication over a single optical fiber. An LC connector may alternative use a duplex design including connection to a pair of optical fibers for separate transmit and receive communications are required between devices, for example. An MPO (multi-fiber push on) connector is configured to multi-fiber cables including multiple sub-units of optical fibers, such as between 4 to 24 fibers. A type of MPO connector may be an MTP connector that may hold 12 fibers and as commercially available by US CONEC LTD. of Hickory, N.C. In embodiments, the MPO connectors may hold 12 fibers, 24 fibers, 36 fibers, or 96 fibers, or another number as suitable per the design parameters for the pre-configured cable 116 as described herein.

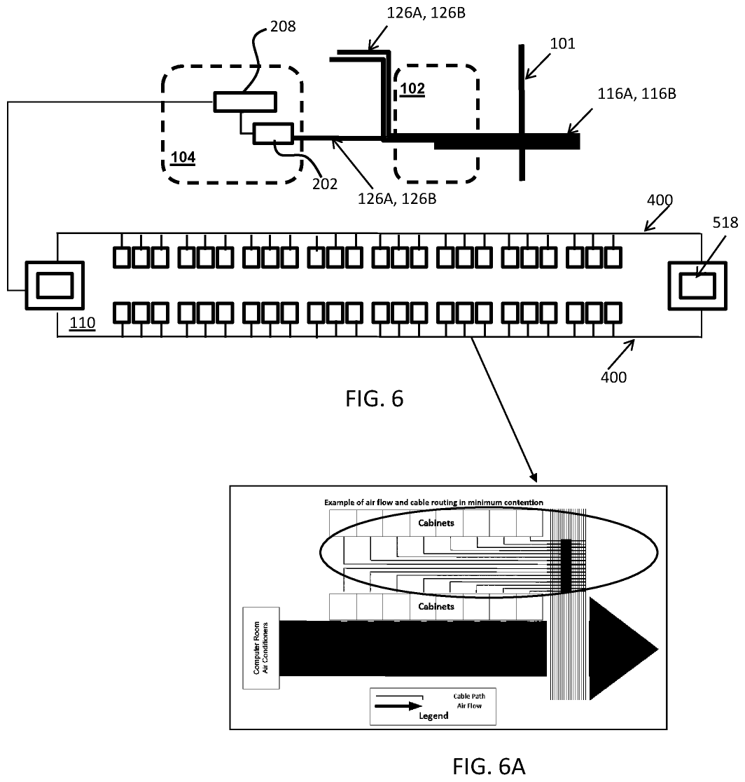

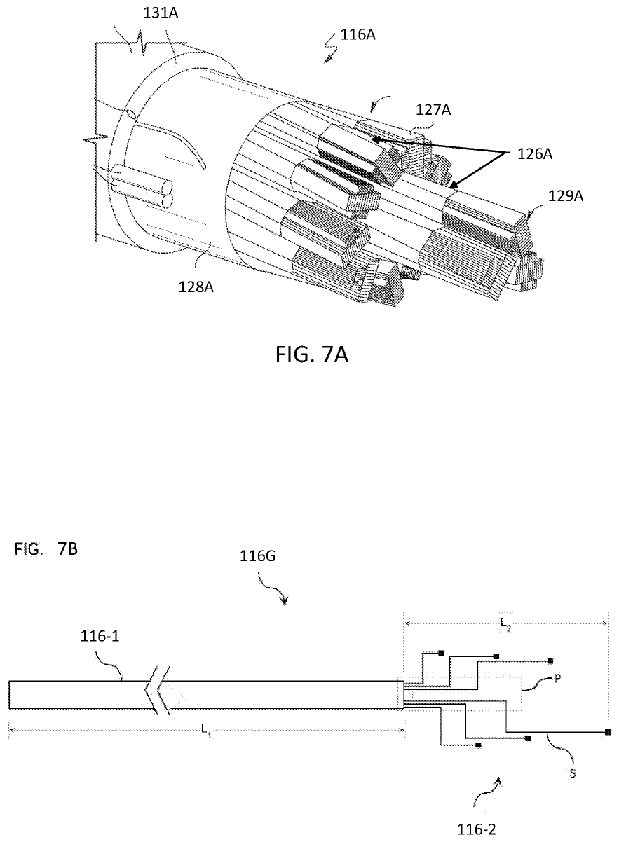

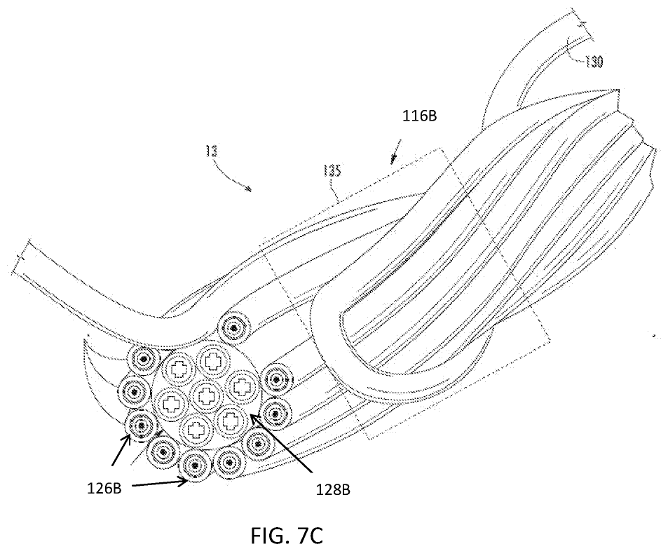

In accordance with yet other aspects of the present invention, as shown in FIG. 6, a novel HFC optical cable 116A of the type shown in FIG. 7A, for example, or 116B, of the type shown in FIG. 7C, may be pre-engineered such that subunits 126A, 126B of the cable 116A, 116B can be routed directly to the MDA 104. By bypassing the splicing step at the optical splice enclosure 118, savings may be realized in time and labor required to set up the data center.

For example, as shown in FIG. 7A, a pre-configured ribbon type cable 116A may be used as the distribution cable and routed from an outside environment into the data center building 101. The pre-configured cable 116A may be comprised of, for example, twelve subunits 126A surrounded by a waterblocking tape 128A with an extruded jacket 131A for protection in an outdoor environment. The cable 116A may be pre-engineered such that the jacket 131A has a shorter longitudinal length than the subunits 126A. Thus, once the cable 126A enters the data center building 101, the jacket 131A is absent to reveal the subunits 126A inside. As shown in FIG. 7A, each subunit 126A may contain 288 optical fibers arranged in stacks of standard optical fiber ribbons. The subunits may be arranged with three of the subunits 126A in a stranded inner layer and nine of the subunits 126A surrounding the inner layer in a stranded outer layer, delivering a total of 3456 fibers to the MDA 104 or other components of the data center 100. The fibers in each subunit may comprise standard optical fiber ribbons arranged in stacks of ribbons 129A. Each optical fiber ribbon may be a standard 12 fiber ribbon or 24 or 36 fiber splittable ribbons for easy splicing. However, other fiber counts and arrangements of fibers are contemplated, including rollable ribbons or loose tube fiber arrangements. The fibers may be surrounded by a flexible, sheath 127A, which allows groups of fibers to be individually routed while remaining protected once in the data center, although there is no longer protection from the more robust outdoor rated jacket 131A. The sheath 127A may comprise a fire-retardant material to enable the indoor portions of the distribution cable 116A to meet fire and smoke ratings. In other aspects, the subunits 126A may be preconnectorized in the factory for connection to panels or switches in the MDA 104. Each subunit 126A may be manufactured to have a precise, predetermined length within 1 meter, so as to extend directly to the area of the MDA 104 desired without having to accommodate excess slack. By coloring the subunit sheaths and/or the ribbons and fibers contained therein, efficient identification and configuration options also enhance the ability to quickly and efficiently identify fibers and connections to wire the data center.

FIG. 7B is a schematic illustration of a generic pre-configured multi-fiber distribution cable 116G according to the present disclosure. In the illustrated embodiment, the pre-configured multi-fiber cable 116G comprises a continuous portion 116-1 of length L1, and an engineered portion 116-2 of length L2. The continuous portion 116-1, is relatively long and may, for example, extend for several hundred or several thousand meters, while the engineered portion 116-2 is relatively short and may, for example, extend for less than 100 m. The continuous portion 116-1 comprises several sub-units S and each sub-unit S comprises a subset of optical fibers. Each sub-unit S may be engineered to a specific length and for a specific type of connectorization, to match the requirements of a particular optical infrastructure. In one embodiment, as described above with respect to cable 116A, for example, each sub-unit S comprises 288 optical fibers, and the continuous portion 116-1 of the cable 116G comprises 12 sub-units S. Accordingly, the continuous portion 116-1 of the pre-configured multi-fiber cable 116A will comprise a total of 3456 optical fibers arranged into 12 sub-units. Given the number and variety of sub-units S provided in the cable 116G, and the nature of the various applications in which the cable 116G is to be installed, a removable protective installation sheath P is provided about the portions of the sub-units S that extend beyond the continuous portion 116-1 of the pre-configured multi-fiber cable 114. In addition, given the overall length of the cable 116G the present disclosure contemplates fiber storage reels loaded with the pre-configured multi-fiber cable 116G.

Although a variety of cable types may be pre-configured according to the methodology described herein, it is contemplated that the ribbon-type cable 116A shown in FIG. 7A, and described in greater detail in International Pub. No. WO2019 010291 A1, and a helically-wound cable 116B shown in FIG. 7C, and described in greater in International Pub. No. WO2019/010291 A1, are two types of multi-fiber optical cables that may be conveniently pre-configured according to aspects of the present disclosure.

The backbone cabling 150 and horizontal cabling 160 form the structured cabling system of a data center 100 that connects the various components or spaces of the data center 100. Data center structured cabling solutions must provide stability and enable system uptime 24 hours per day, seven days per week. For the system to be effective, the cabling must be organized in such a way that individual fibers are easy to locate, and moves, adds and changes are easily managed.

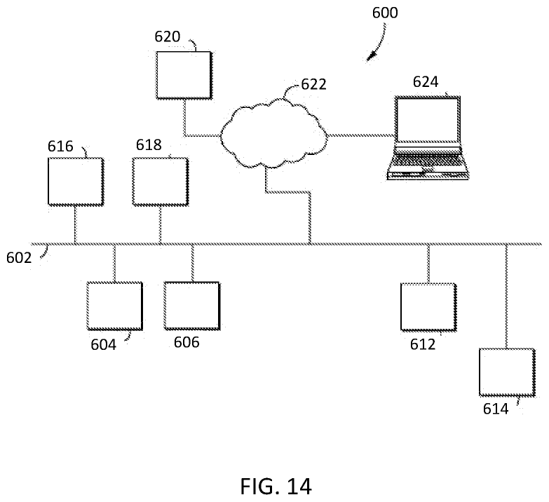

The type of cable shown in FIG. 7C may be used as a backbone cable 150 in the data center 100. FIG. 7C illustrates a type of helical wound cable for use as the optimized, customized pre-configured cable 116B designed by a configurator module 612 (see FIG. 14) as described herein that may be used with, for example, the embodiments of data center 100 disclosed herein. The cable 116B may include pre-determined drop locations 13 as determined by the configurator module 612, and as described in greater detail further below, and restraint features 135 at the pre-determined drop locations 13 for each respective drop sub-unit 130. The cable 116B may include a core 128B having sub-units 126B respectively including multiple optical fibers therein. The core 128B may be surrounded by additional sub-units 126B as well. In embodiments, pulling grip components may designed to be located at the pre-determined drop locations 13 on the cable 116B, or any cable 116 as described herein. Embodiments of the cable 116B may include multiple layers of sub-units 126B helically wound and/or may include a center member extending therethrough.

The connectorized ends of backbone or optical trunk cables are shipped from the factory, installed in a covering that protects the connectors from damage during transit and cable installation. Preterminated plug-and-play system connector modules may provide the interface between the MTP/MPO connectors on the backbone cables and the electronics ports. The module may contain one or two MTP adapters at the back of the module, and simplex or duplex adapters on the front of the module. LC, SC, MT-RJ, or ST connector styles may be available on the front, and an optical assembly inside the module connects the front adapters to the MTP adapter(s) on the rear of the module.

The connector requested on the front side usually is determined by the connector style in the electronics, so that hybrid patch cords (which have different interfaces on each end, such as an LC on one end and an SC on the other) are not needed. The most common connector type in the data center currently is the LC.

Other types of backbone cables 150 include optical trunk cables of varying fiber counts. For larger fiber counts, ribbon cables may provide high fiber density and a resultant smaller cable diameter. The backbone cables 150 are typically more robust and may include armor options to withstand the more rigorous demands of being pulled and routed throughout the data center in trays and or ducts, or hung in overhead ladder racks, for example.

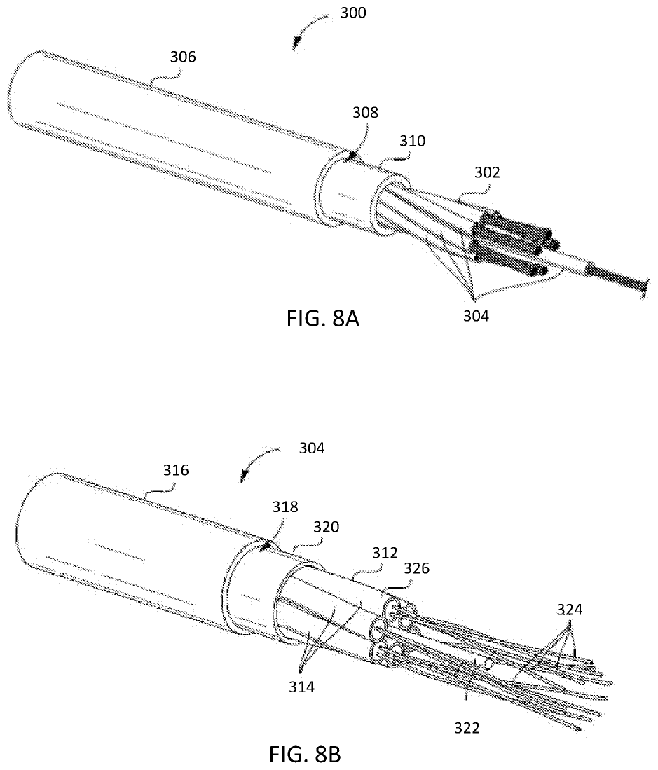

FIGS. 8A-8B are views of a section of a fiber optic distribution cable 300, in accordance with aspects of the present disclosure. Referring to FIG. 8A, the distribution cable 300 includes a cable bundle 302 (may also be referred to herein as a cable core) of a plurality of subunit cables 304 and a distribution jacket 306 (may also be referred to as outer jacket, etc.) defining a distribution interior 308. The cable bundle 302 of the subunit cables 304 is disposed in the distribution interior 308 of the distribution jacket 306. In certain embodiments, the distribution jacket 306 is formed from, for example, a flame-retardant polymer material.

In certain embodiments, a strain-relief component 310 may be disposed within the distribution interior 308 of the distribution jacket 306 between the cable bundle 302 of the subunit cables 304 and the distribution jacket 306. The strain-relief component 310 surrounds and/or is interspersed among the cable bundle 302 of the subunit cables 304. In certain embodiments, the strain-relief component 310 may be, for example, a layer of longitudinally-extending yarns for absorbing tensile loads on the cable bundle 302. In certain embodiments, the strain-relief component 310 includes a dispersed layer of aramid strands in the region between the distribution jacket 306 and the cable bundle 302 of subunit cables 304.

In the illustrated embodiment, the cable bundle 302 has eight subunit cables 304. However, other embodiments could include more or fewer subunit cables 304 depending on cabling requirements. In certain embodiments, one or more layers of subunit cables 304 may be provided depending on the fiber densities needed and/or other desired parameters (e.g., limitations on the outside diameter of the distribution cable 300). The distribution cable 300 and/or the subunit cables 304 may have generally circular cross-sections, although other cross-sections (e.g., oval, elliptical, etc.) may be used. The illustrated cables and subunit cables may not have perfectly circular cross-sections, and any citations of diameters may represent an average diameter of a generally circular cross-section. In certain embodiments, as illustrated, the cable bundle 302 is stranded such that the subunit cables 304 are helically twisted around a longitudinal axis of the cable bundle 302. In certain embodiments, an outer layer of a plurality of subunit cables 304 is stranded around an inner layer of subunit cables 304 to provide higher fiber densities. This reduces any stress or strain concentrations on any one subunit cable 304 (e.g., from bending of the distribution cable 300). In certain embodiments, a central strength element (not shown) may be provided and the subunit cables 304 may be stranded around the central strength element. In yet other cable applications, stranding may not be used and the subunit cables 304 may run substantially parallel through the distribution cable 300.

Referring to FIG. 8B, each subunit cable 304 (may also be referred to herein as a micromodule or a routable subunit, etc.) includes a subunit bundle 312 (may also be referred to herein as a subunit core) of a plurality of tether cables 314 (may also be referred to herein as tether subunits) and a subunit jacket 316 defining a subunit interior 318. The subunit bundle 312 of the tether cable 314 is disposed in the subunit interior 318 of the subunit jacket 316. In certain embodiments, the subunit jacket 316 is formed from, for example, a flame-retardant polymer material.

In certain embodiments, a strain-relief component 320 may be disposed within the subunit interior 318 of the subunit jacket 316 between the subunit bundle 312 of the tether cables 314 and the subunit jacket 316. The strain-relief component 320 surrounds and/or is interspersed among the subunit bundle 312 of the subunit cables 304. In certain embodiments, the strain-relief component 320 may be, for example, a layer of longitudinally-extending yarns for absorbing tensile loads on the subunit bundle 312. In certain embodiments, the strain-relief component 320 includes a dispersed layer of aramid strands in the region between the subunit jacket 316 and the subunit bundle 312 of tether cables 314.

In certain embodiments, a central strength element 322 may be disposed in a center of the subunit bundle 312, and thereby within the subunit interior 318 of the subunit jacket 316. The tether cables 314 may be stranded (e.g., helically twisted) around the central strength element 322. In certain embodiments, an outer layer of a plurality of tether cables 314 is stranded around an inner layer of tether cables 314 to provide higher fiber densities. In yet other cable applications, stranding may not be used and the tether cables 314 may run substantially parallel through the subunit cable 304. The central strength element 322 provides strain-relief and absorbs loads from the tether cables 314.

In the illustrated embodiment, the subunit bundle 312 has six tether cables 314. However, other embodiments could include more or fewer tether cables 314 depending on cabling requirements. In certain embodiments, one or more layers of tether cables 314 may be provided depending on the fiber densities needed and/or other desired parameters (e.g., limitations on the outside diameter of the distribution cable 300). In certain embodiments, as illustrated, the subunit bundle 312 is stranded such that the tether cables 314 are helically twisted around a longitudinal axis of the subunit bundle 312. This reduces any stress or strain concentrations on any one tether cable 314 (e.g., from bending of the distribution cable 300 and/or subunit cable 304).

Each tether cable 314 includes one or more optical fibers 324 (may also be referred to herein as optical fiber waveguides). In certain embodiments, the optical fibers 324 in the subunit cable 304 may be furcated into separate tether cables 314 within the core of the subunit cable 304. Each tether cable 314 may include a tether jacket 326 to surround a select number of optical fibers 324 in the tether cable 314. As an example, as illustrated, each subunit cable 304 includes six tether cables 314, and each tether cable 314 includes two optical fibers 324. In other words, each subunit cable 304 includes 12 optical fibers 324. Other numbers of subunit cables 304, and/or tether cables 314, and/or optical fibers 324 can be employed for various applications, however. For example, in certain embodiments, each subunit cable 304 includes 2-24 optical fibers. Further, the diameters and thicknesses of the distribution cable 300, the subunit cables 304, and/or the tether cables 314 may vary according to the number of optical fibers 324 enclosed therein, and according to other factors.

In various embodiments, the distribution jacket 306, the subunit jacket 316, and/or the tether jacket 326 may be formed from an extrudable polymer material that includes one or more materials, additives, and/or components embedded in the polymer material that provides fire resistant characteristics, such as relatively low heat generation, low heat propagation, low flame propagation, and/or low smoke production. For example, the distribution jacket 306, the subunit jacket 316, and/or the tether jacket 326 may be made from a flame-retardant PVC. In various embodiments, the fire-resistant material may include an intumescent material additive embedded in the polymer material. In other embodiments, the fire-resistant material may include a non-intumescent fire-resistant material embedded in the polymer material, such as a metal hydroxide, aluminum hydroxide, magnesium hydroxide, etc., that produces water in the presence of heat/fire which slows or limits heat transfer along the length of the distribution cable 300, subunit cables 304, and/or tether cables 314. In certain embodiments, the distribution jacket 306, the subunit jacket 316, and/or the tether jacket 326 may be formed from fire-retardant materials to obtain a desired plenum burn rating. For example, highly-filled PVCs of specified thicknesses can be used to form these components. Other suitable materials include low smoke zero halogen (LSZH) materials such as flame-retardant polyethylene and PVDF.

In certain embodiments, the strain-relief component 310 and/or strain-relief component 320 may utilize tensile yarns as tension relief elements that provide tensile strength to the cables 300, 304, 314. In certain embodiments, a preferred material for the tensile yarns is aramid (e.g., KEVLAR®), but other tensile strength materials could be used, such as high molecular weight polyethylenes (e.g., SPECTRA® fiber and DYNEEMA® fiber, Teijin Twaron® aramids, fiberglass, etc.). In certain embodiments, the yarns may be stranded to improve cable performance.

The components of the distribution cable 300, such as the subunit cables 304, can be constructed of selected materials of selected thicknesses such that the distribution cable 300 achieves plenum burn ratings according to desired specifications. The subunit cables 304 can also be constructed so that they are relatively robust, such that they are suitable for field use, while also providing a desired degree of accessibility. For example, in certain embodiments, the subunit cables 304 can be constructed with thicker subunit jackets 316 which provide sufficient protection for the fibers such that the subunit jackets 316 may be used as furcation legs.

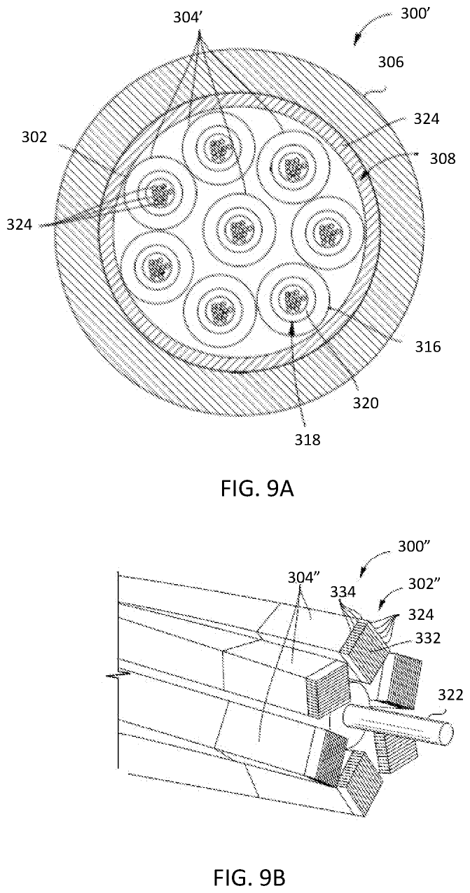

FIG. 9A is a cross-sectional view of an embodiment of the distribution cable 300′ of FIGS. 8A-8B, in accordance with aspects of the present disclosure. Each of the subunit cables 304′ includes optical fibers 324 loosely disposed within the subunit cable 304′ (e.g., in an essentially parallel array). In certain embodiments, the optical fibers 324 may be coated with a thin film of powder (e.g., chalk, talc, etc.) which forms a separation layer that prevents the fibers from sticking to the molten sheath material during extrusion. The subunit cable 304′ may be further encased in an interlocking armor for enhanced crush resistance.

FIG. 9B is a cross-sectional view of another embodiment of the distribution cable 300″. Each of the subunit cables 304″ of the cable bundle 302″ is a stack 332 of fiber ribbons 334. Each fiber ribbon 334 includes a plurality of optical fibers 324. In certain embodiments, as illustrated, the subunit cables 304″ are stranded around a central strength element 322, and/or each subunit cable 304″ is stranded.

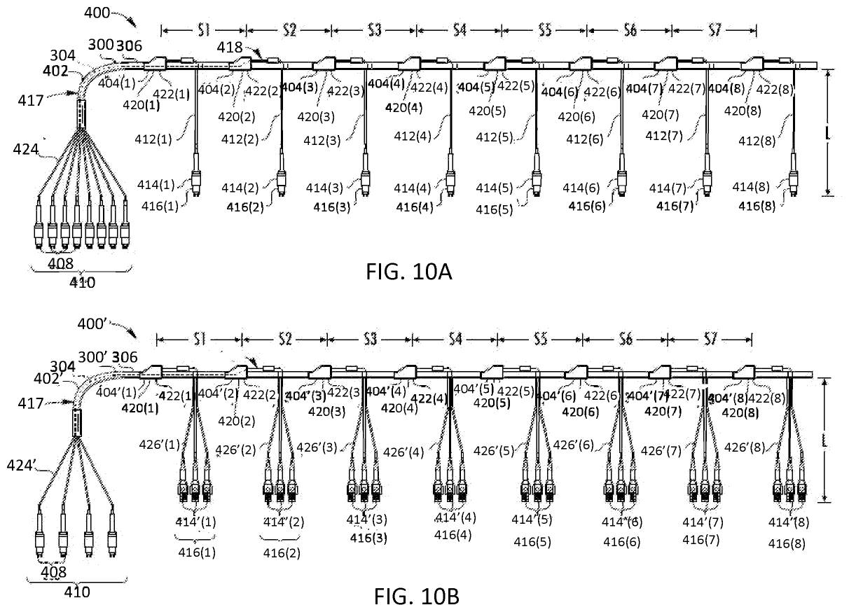

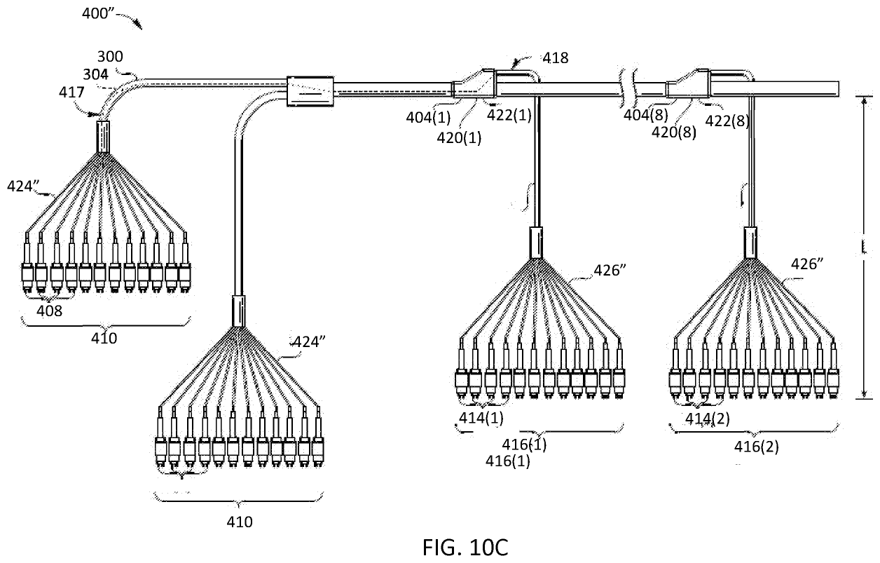

FIGS. 10A-10C are embodiments of a distribution cable assembly 400 incorporating the distribution cable of FIGS. 8A-9B. Referring to FIG. 10A, the distribution cable assembly 400 includes a distribution subunit 402 (may also be referred to herein as a main subassembly) and a plurality of tap subunits 404(1)-404(8) (may also be referred to herein as a branch subassembly, drop subunit, etc.). The distribution subunit 402 includes a distribution cable 300, 300′ (referred to generally herein as distribution cable 300) and distribution connectors 408(1)-408(8) at a distribution end 410 (may also be referred to herein as upstream end). Each of the plurality of tap subunits 404(1)-404(8) includes a tap cable 412(1)-412(8) (may also be referred to herein as a drop cable) and tap connectors 414(1)-414(8) at a tap end 416(1)-416(8) (may also be referred to herein as downstream end). In certain embodiments, subunit cables 304 extend from the distribution connector 408 to respectively one of the plurality of tap connectors 412(1)-412(8), each at a different tap point 420(1)-420(8) (may also be referred to herein as drop point, terminated access point, etc.) along a length of the distribution cable 300. For example, subunit cable 304 extends from the distribution connector 408 through the distribution cable 300 to the tap connector 414(2). The spacing between tap points 420(1)-420(8) depends on the application and cabling requirements. In addition, each subunit cable may distribute the optical fibers contained therein uninterrupted from the distribution connector 408 to the respective tap connector 414 without splicing of any fiber therebetween.

The distribution connectors 408(1)-408(8) are in optical communication with the tap connectors 414(1)-414(8) (may be referred to generally as tap connectors 414), where the distribution cable assembly 400 is pre-connectorized, such as for connection to a patch panel (e.g., at a goalpost). Any conventional or yet-to-be developed optical connector or connectorization scheme may be used in accordance with the present disclosure, including, but not limited to, small (e.g., LC) and multi-fiber (e.g., MPO/MTP) connectors as commercially available. The distribution cable assembly 400 includes a distribution portion 417 of the subunit cable 304 that extends from the distribution connectors 408(1)-408(8) through the distribution cable 300. The distribution cable assembly 400 further includes tap portions 418(1)-418(8) of the subunit cable 304 that extends from the distribution cable 300 to the tap connectors 412(1)-412(8). A junction shell 422(1)-422(8) at each tap point 420(1)-420(8) facilitates and protects routing of the subunit cable 304 from the distribution cable 300.

In certain embodiments, as illustrated in FIG. 10A, the distribution subunit 402 includes a distribution tether 424 at the distribution end 410. The distribution tether 424 may be pre-connectorized and extend a predetermined length L from the distribution jacket 306. Further, the distribution tether 424 includes distribution connectors 408(1)-408(8) coupled to ends of the distribution tether 424. Whether to include a distribution tether 424 may depend on the cabling requirements (e.g., routing requirements, connector requirements, etc.). Similarly, the tap subunits 404(1)-404(8) are pre-connectorized such that the tap cables 412(1)-412(8) extend a predetermined length L from the distribution jacket 306. Further, the tap subunits 404(1)-404(8) include tap connectors 412(1)-412(8) coupled to an end of the tap subunits 404(1)-404(8). In certain embodiments, each of the distribution connectors 408(1)-408(8) and/or tap connectors 414(1)-414(8) includes an MPO (multi-fiber push on) connector, which is configured for multi-fiber cables including multiple sub-units of optical fibers (e.g., between four to 24 fibers). A type of MPO connector may be an MTP connector that may hold 12 fibers and is commercially available by US CONEC LTD. of Hickory, N.C. MPO connectors may hold 12 fibers, 24 fibers, 36 fibers, or 96 fibers, or another number as suitable per the design parameters for the pre-configured cable.

In certain embodiments, as illustrated in FIG. 10B, the distribution cable assembly 400′ includes the distribution subunit 402′ with a distribution tether 424′ at the distribution end 410, which is pre-connectorized with MPO connectors. Further, the tap subunits 404′(1)-404′(8) includes tap tethers 426′(1)-426′(8) at the tap ends 416′(1)-416′(8), which is pre-connectorized with tap connectors 414′(1)-414′(8) including LC connectors. An LC connector may include a simple design for a single optical fiber for transmission in a single direction (e.g., transmit or receive) or when a multiplex data signal is used for bi-directional communication over a single optical fiber. An LC connector may alternatively use a duplex design including connection to a pair of optical fibers for when separate transmit and receive communications are required between devices, for example.

FIG. 10C is a schematic view of another embodiment of a preconnectorized distribution cable assembly 400″ illustrating multiple distribution tethers 424″ and multiple tap tethers 426″. Such configurations may be used to increase fiber density and/or for certain routing configurations, such as by routing each distribution tether 424″ to each tap tether 326″.

As discussed above, the cabling topology for a data center includes many different types of cabling, such as high fiber count cables (e.g., 3,000+ fibers) coming into the data center and all the structured cabling to connect all of the switches and equipment internal to the data center. The data center structured cabling may be categorized as backbone cabling and horizontal cabling.

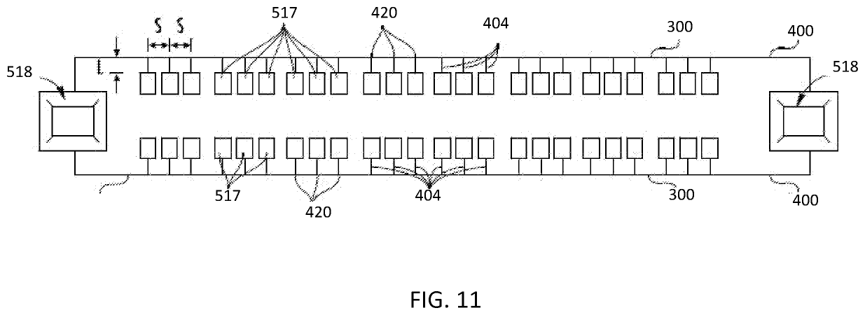

FIG. 11 is a close-up, schematic view of equipment racks and distribution cables in a data center, in accordance with aspects of the present disclosure (see also FIG. 6). A pre-configured and preconnectorized cable such as distribution cable assembly 400, 400′, 400″ (referred to herein generally as distribution cable assembly 400) may be used to connect the servers 517 in the racks or cabinets in the EDA 110 to the MDA 104 via one or more edge of rack units 518 (also referred to as goalposts). The exact drop or tap locations and run lengths for the individual tap subunits 404, 404′, 404″ (referred to herein generally as tap subunit 404) may be pre-engineered and pre-connectorized to replace the many individual cables typically provided (refer to FIG. 6A). In conventional systems, each cabinet would require a different cable. Comparatively, disclosed herein are distribution cable assemblies 400 with a single distribution cable 300 with multiple tap points 420, thereby greatly reducing cabling clutter and simplifying installation.

The most efficient optical infrastructure is one in which all or most of the components are preterminated in the factory and the cables are designed to fit efficiently in the confined spaces of the datacenter without excess cable. In certain embodiments, all connectors are installed and tested in the factory and packaged such that components are not damaged during installation. The installer simply unpacks the components, pulls the preconnectorized cable assembly into place, snaps in all of the connectors and the system is up and running. Accordingly, the cable assembly 400, 400′, 400″ depicted in FIGS. 8A-10C may be particularly suitable for the structured cabling requirements of a datacenter.

In certain embodiments, the plurality of tap subunits 404 (e.g., premanufactured) of the distribution cable assembly 400 are spaced apart by a predetermined distance S and/or of a predetermined length L based on, for example, location in a datacenter and/or distance to specific equipment, etc. In particular, the distribution cable assembly 400 could be manufactured such that each individual tap subunit 404 has a predetermined length L according to the configuration of the data center and where along the distribution cable 100 the tap subunit 404 will branch away. Further, the tap units 404 may be premanufactured such that each has a predetermined length L according to the configuration of the data center (e.g., spacing S between servers) and location along the distribution cable.

Although the concepts of the present disclosure are described herein with primary reference to a data center, it is contemplated that the concepts will enjoy applicability to any outdoor and indoor waveguide system associated with digital infrastructure data including an infrastructure layout. For example, and not by way of limitation, it is contemplated that the concepts of the present disclosure will enjoy applicability to indoor warehouses and/or commercial buildings.

Prewiring a data center with optical connectivity according to an efficient, pre-engineered architecture is the best way to provide bandwidth where it is needed. Using a zone architecture and providing space for future growth, along with selecting the appropriate optical fiber and cable types, is the best way to ensure a long-term, reliable, easy-to-scale infrastructure that installs quickly. In accordance with aspects of the present disclosure, a configurator design tool may be used to document these data center requirements to efficiently produce a pre-engineered network solution with cables preconnectorized in the factory and designed to length.

The configurator tool accounts for the type and location of all equipment in the data center, the cabling and connections required, and so many other factors such as cold and hot aisle configurations in the server room, access floor routing, overhead or underfloor tray systems, flame retardancy requirements, conduit placement and dimensions, etc. The tool may assist with efficient design and cabling requirements, taking into consideration that overhead telecommunications cabling may improve cooling efficiency and is a best practice where ceiling heights permit because it can substantially reduce airflow losses due to airflow obstruction and turbulence caused by under floor cabling and cabling pathways.

If telecommunications cabling is installed in an under-floor space that is also used for cooling, under floor air obstructions can be reduced by using network and cabling designs (e.g., top-of-rack switching) that require less cabling such as the bundled and tapered cable designs disclosed herein. As well, the tool aids in selecting cables with smaller diameters to minimize the volume of under floor cabling; utilizing higher strand count optical fiber cables instead of several lower count optical fiber cables to minimize the volume of under floor cabling; designing the cabling pathways to minimize adverse impact on under floor airflow (e.g., routing cabling in hot aisles rather than cold aisles so as not to block airflow to ventilated tiles on cold aisles); designing the cabling layout such that the cabling routes are opposite to the direction of air flow so that at the origin of airflow there is the minimal amount of cabling to impede flow; and properly sizing pathways and spaces to accommodate cables with minimal obstruction (e.g., shallower and wider trays).

By way of example, and not as a limitation, and as described with respect to a system 600 of FIG. 11 below, the configurator design tool may at least partially embody a software-enabled configurator module 612 that uses input representing the digital infrastructure data of the data center 100 and building 101 to design one or more pre-configured distribution cables 116 or 300, and/or structured cabling assemblies to serve as backbone cables 150 and horizontal cables 160 that are customized and optimized for use with the data center 101, including the cable assemblies 400, 400′, and 400″ disclosed herein. Such optimization enables increased data capacity in the data network as described herein through minimization of the use of splices during installation and through minimization of the number of connectors in the data network.

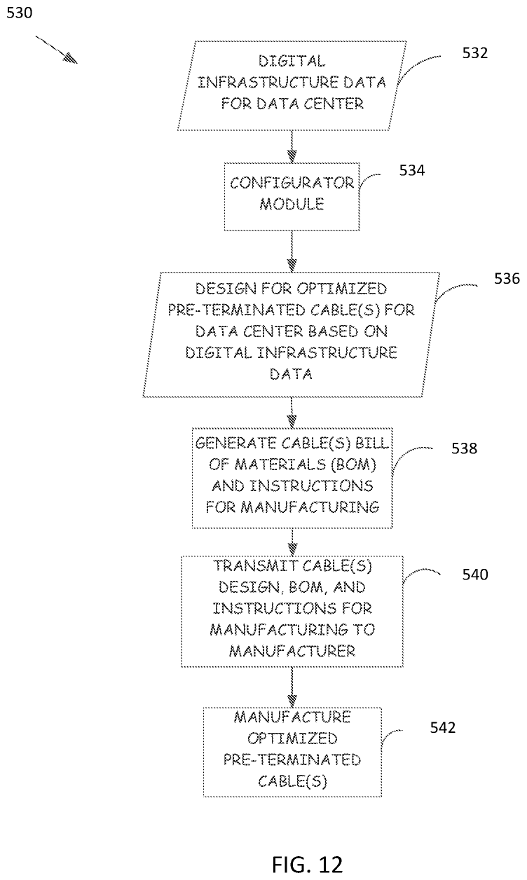

FIG. 12 illustrates a process 530 for designing and manufacturing optimized, customized pre-engineered cables designed by a configurator module 612 (see FIG. 14). In block 532, digital infrastructure data for the data center 100 is provided as an input. The configurator module 612 may determine whether a user of the configurator module 612 has access to digital infrastructure data for the data center 100 and building 101. If not, the user may design and upload the digital infrastructure data to the configurator module 612. If so, the user may access and upload the digital infrastructure data to the configuration module. As a non-limiting example, the user may import a 2D design and/or 3D design for the digital infrastructure data. The 2D design may include a floor plan that the configuration module 612 may scale for use. The user may further use a 3D design tool storing the 3D design and import the 3D design from the 3D design tool into the configuration module. The configuration module may be used for manual and/or automatic revision of missing elements from the digital infrastructure data.

The digital infrastructure data of the data center 100 and building 101 may be input into the configurator module 612 in block 534, and may include a scaled floor plan, server, tray and rack locations, a number of chassis in a rack, a height, width, and number of connection ports in a chassis, and like information. Through use of the configuration module 612, one or more drop point locations may be inserted into the digital infrastructure data, as described in greater detail further below.

In block 536, the configurator module 612 embodied in the configurator design tool of the present disclosure is used to generate a design for one or more optimized pre-configured cables (e.g., distribution cables 116A, 116B, optimized backbone cables 150, horizontal cables 160, including cables 300, 300′, 300″, 400, 400′, 400″) for the data center building 100 based on the digital infrastructure data and determined drop point locations. The design may be generated on top of the digital infrastructure data. In an embodiment, the design for the one or more optimized pre-configured cables for the data center building may be displayed atop the digital infrastructure data of the data center 100 on a user interface of the configurator module 612. The design may be modifiable by a user of the configurator module 612 and/or automatically based on received or modified design parameters. By way of example, and not as a limitation, such design parameters may include, but not be limited to, attenuation parameters, optical light budgets, data rates, fire retardant requirements, and the like. In an embodiment, a user may select an order button in the configurator module 612 once satisfied with the presented generated design of the one or more optimized pre-configured cables for the data center 100.

In block 538, a bill of materials may be generated by the configurator module 612 along with instructions for manufacture for the designed one or more optimized pre-configured cables for the data center 100 of block 536. In embodiments, the configurator module 612 generates, as part of the bill of materials and instructions for each optimized and customized pre-configured cable, cable specifications including, but not limited to, length, jacket type, color, pull grip types and locations, pre-terminated/connectorized point locations and connector types, packaging and transport information, and the like.

In block 540, the design for the pre-configured cables for the data center 100, the bill of materials, and the instructions for manufacture may be transmitted by the configurator module 612 to a manufacturer. In block 542, the manufacturer may manufacture the optimized pre-configured cables and cable assemblies for the data center 100 based on the bill of materials and the instructions for manufacture.

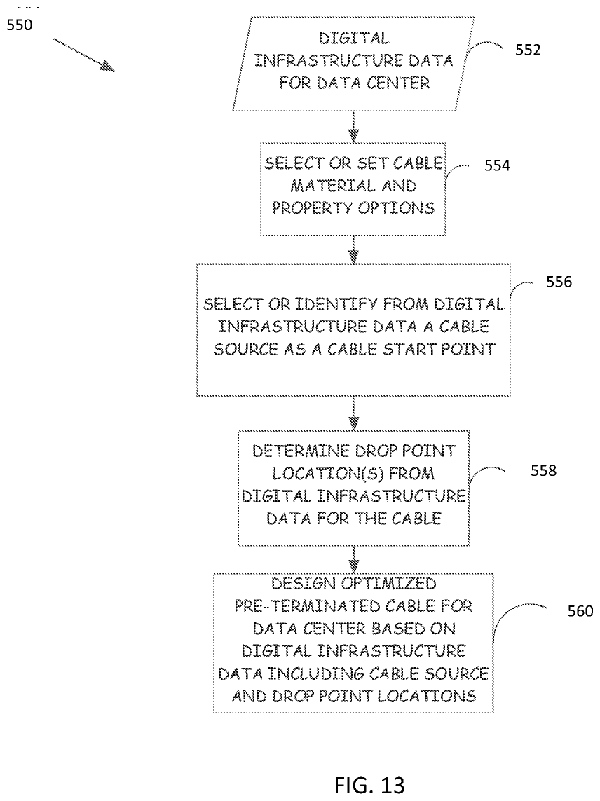

FIG. 13 illustrates a process 550 for use of a configurator module 612 to create designs for optimized, customized pre-configured cables. In block 552, the digital infrastructure data for a data center 100 is input into the configurator module 612 as described above with respect to the process 530 of FIG. 12. In block 554, within the configurator module 612, one or more cable material and/or property options may be set or selected by a user and/or the configurator module 612. As a non-limiting example, available and/or desired cable family types and properties stored in a database communicatively coupled to the configurator module 612 may be selected and retrieved for use with the design of the optimized, customized, pre-engineered and pre-configured cable. Design parameters and/or cable properties may include, for example, cable weight, cable length, optical fiber capacity number, sub-unit capacity number, a size of an optical fiber diameter and/or cable diameter, cable tray parameters such as size and weight limitations, and cable attributes such as cables suitable for flame retardant areas. In an embodiment, a cable length may be in a range between 20 m to 200 m, such as between 100 m to 200 m, or between 20 m to 25 m. The design for the optimized, customized pre-configured cables assists to reduce cable tray congestion and provide for easier, less costly and time-consuming installation.

The cable or cables for the data center 100 are pre-configured such that it is suitable for direct installation in the data center building 101 without need for additional cutting, splicing, and connectorization to determine and create drop locations to server racks. These drop locations are pre-engineered and pre-terminated in the cable at select locations in select optical fibers along the cable length. Use of such a pre-engineered cable, customized and optimized for the data center 100, greatly reduces installation time and labor costs, and increases efficiency and performance of the optical fiber network in the data center 100.

In block 556, a cable source as a cable start point for a pre-configured cable (116A, 116B, 150, 160, 300 or 400) is selected within and/or identified by the configurator module 612 with respect to and from the digital infrastructure data of the data center 100. The design of the pre-configured cable including the cable source may be overlaid on a floor layout included in the digital infrastructure data of the data center 100 and viewable on a user interface of the configurator module 612.

In block 558, one or more drop point locations 13 for one or more optical fibers of the pre-configured cable are determined from the digital infrastructure data of the data center 100 by the configurator module 612. A user and/or configurator module 612 may determine a drop point location 13 one at a time until a pre-determined total number of drops point locations 13 are determined. For each drop point location 13, a location of the drop point location 13 on the pre-configured cable and associated location in the digital infrastructure data of the data center 100 is determined, along with a number of connectors and connections to be made with respect to the pre-configured cable. The one or more drop point locations 13 may be selected by a user and/or automatically generated by the configurator module 612. The one or more drop point locations 13 may be modifiable by the user and/or automatically by the configurator module 612 based on different and/or additional input parameters such as a change in cable family types and/or properties.

In block 560, the customized, optimized pre-configured cable is designed by the configurator module 612 for the data center 100 based on the digital infrastructure data including the cable source and drop point locations. The customized, optimized pre-configured cable is designed by the configurator module 612 for the data center building 100 further based on the digital infrastructure data including the determined cable family types and/or properties options available.

FIG. 14 illustrates a computer implemented system 600 for use with the processes 530 or 550 of FIG. 12 or FIG. 13. Referring to FIG. 14, a non-transitory system 600 for implementing a computer and software-based method to utilize system design tools for designing, ordering, and providing manufacturing and installation instructions and specifications for the one or more pre-configured cables described herein is illustrated as being implemented along with using a graphical user interface (GUI) that is accessible at a user workstation (e.g., a computer 624 or mobile device), for example. The system 600 comprises a communication path 602, one or more processors 604, a non-transitory memory component 306, the configurator module 612, which is embodied in the configurator design tool, database 614, an optimization component 616, network interface hardware 618, a network 622, a server 620, and the computer 624. The various components of the system 600 and the interaction thereof will be described in detail below.

While only one application server 620 and one user workstation computer 624 is illustrated, the system 600 can comprise multiple application servers containing one or more applications and workstations. In some embodiments, the system 600 is implemented using a wide area network (WAN) or network 622, such as an intranet or the Internet. The workstation computer 624 may include digital systems and other devices permitting connection to and navigation of the network. Other system 600 variations allowing for communication between various geographically diverse components are possible. The lines depicted in FIG. 14 indicate communication rather than physical connections between the various components.

The system 600 comprises the communication path 602. The communication path 602 may be formed from any medium that can transmit a signal such as, for example, conductive wires, conductive traces, optical waveguides, or the like, or from a combination of mediums capable of transmitting signals. The communication path 602 communicatively couples the various components of the system 600. As used herein, the term “communicatively coupled” means that coupled components are capable of exchanging data signals with one another such as, for example, electrical signals via conductive medium, electromagnetic signals via air, optical signals via optical waveguides, and the like.

The system 600 of FIG. 14 also comprises the processor 604. The processor 604 can be any device capable of executing machine readable instructions. Accordingly, the processor 304 may be a controller, an integrated circuit, a microchip, a computer, or any other computing device. The processor 604 is communicatively coupled to the other components of the system 600 by the communication path 602. Accordingly, the communication path 602 may communicatively couple any number of processors with one another, and allow the modules coupled to the communication path 602 to operate in a distributed computing environment. Specifically, each of the modules can operate as a node that may send and/or receive data.

The illustrated system 600 further comprises the memory component 606 which is coupled to the communication path 602 and communicatively coupled to the processor 604. The memory component 606 may be a non-transitory computer readable medium or non-transitory computer readable memory and may be configured as a nonvolatile computer readable medium. The memory component 606 may comprise RAM, ROM, flash memories, hard drives, or any device capable of storing machine readable instructions such that the machine-readable instructions can be accessed and executed by the processor 604. The machine-readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 606. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 14, as noted above, the system 600 comprises the display such as a GUI on a screen of the computer 624 for providing visual output such as, for example, information, designs of one or more pre-configured cables virtually overlaid as an fiber-optic infrastructure on the a scaled floor layout from digital infrastructure data of a data center 100 including a cable source and drop point locations, graphical reports, messages, or a combination thereof. The display on the screen of the computer 624 is coupled to the communication path 602 and communicatively coupled to the processor 604. Accordingly, the communication path 602 communicatively couples the display to other modules of the system 600. The display can comprise any medium capable of transmitting an optical output such as, for example, a cathode ray tube, light emitting diodes, a liquid crystal display, a plasma display, or the like. Additionally, it is noted that the display or the computer 624 can comprise at least one of the processor 304 and the memory component 606. While the system 600 is illustrated as a single, integrated system in FIG. 14, in other embodiments, the systems can be independent systems.

The system 600 comprises the configurator module 612 as described above and the optimization component 616 for determining an optimized design for a pre-configured cables from a plurality of design options based on digital infrastructure data, selected cable family type and/or properties, determined cable source, determined cable drop point locations, number of connectors, attenuation attributes, material attributes such as flame retardant area requirements, and the like. The optimization component 616 may utilize an optimized model, such as a constrained optimization module, to minimize error and determine an optimized design from a plurality of design options for a pre-configured cable 614 for a data center building 100 to increase associated optimal performance. The optimization component 616 and the configurator module 612 are coupled to the communication path 602 and communicatively coupled to the processor 604. As will be described in further detail below, the processor 604 may process the input signals received from the system modules and/or extract information from such signals.

The system 600 comprises the network interface hardware 618 for communicatively coupling the system 600 with a computer network such as network 622. The network interface hardware 618 is coupled to the communication path 602 such that the communication path 602 communicatively couples the network interface hardware 618 to other modules of the system 600. The network interface hardware 618 can be any device capable of transmitting and/or receiving data via a wireless network. Accordingly, the network interface hardware 618 can comprise a communication transceiver for sending and/or receiving data according to any wireless communication standard. For example, the network interface hardware 618 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 14, data from various applications running on computer 624 can be provided from the computer 624 to the system 600 via the network interface hardware 618. The computer 624 can be any device having hardware (e.g., chipsets, processors, memory, etc.) for communicatively coupling with the network interface hardware 618 and a network 622. Specifically, the computer 624 can comprise an input device having an antenna for communicating over one or more of the wireless computer networks described above.

The network 622 can comprise any wired and/or wireless network such as, for example, wide area networks, metropolitan area networks, the Internet, an Intranet, satellite networks, or the like. Accordingly, the network 622 can be utilized as a wireless access point by the computer 624 to access one or more servers (e.g., a server 620). The server 620 and any additional servers generally comprise processors, memory, and chipset for delivering resources via the network 622. Resources can include providing, for example, processing, storage, software, and information from the server 620 to the system 600 via the network 622. Additionally, it is noted that the server 620 and any additional servers can share resources with one another over the network 622 such as, for example, via the wired portion of the network, the wireless portion of the network, or combinations thereof.

In embodiments, the optimization component 616 and the configurator module 612 may design a fiber-optic infrastructure for digital infrastructure data of a data center building 100 that is based on optical performance and upgradability. As a non-limiting example, the configuration module 612 may design one or more pre-configured cables for current use and an upgrade path to allow for one or more pre-configured cables with upgraded functionality, such as for use with an increased speed, for future use at the data center 100.

The configurator design tool described herein for designing a customized, pre-configured multi-fiber optical cable for use in a data center based on digital infrastructure data of the data center reduces and/or eliminates splices during field installation, reduces a number of connections, improves routing and complexity of managing optical connections in the data center, reduces and/or eliminates labeling and testing, and increasing efficiency with respect to optical fiber cable design and a design to order process for current and/or future use. The pre-configured cable design may be manufacturing through a low-cost and optimized solution such that splicing, termination, labeling, testing and like occurs prior to transport of the pre-configured cable to a site, such as the data center, for installation.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A distribution cable assembly, comprising:
a distribution cable having a distribution end and longitudinal length, the distribution cable comprising:
a distribution jacket defining a distribution interior;
a plurality of subunit cables disposed within the distribution interior, each subunit cable comprising a subunit jacket defining a subunit interior; and
a plurality of optical fibers disposed within the subunit jacket;
a plurality of distribution connectors, each distribution connector attached to one or more of the optical fibers at the distribution end;
a plurality of tap connectors, each tap connector defining a tap end and terminating one or more of the plurality of optical fibers from a respective distribution connector;
wherein each subunit cable routes the one or more of the plurality of optical fibers from one of the plurality of distribution connectors to one of the plurality of tap connectors through a different tap point along the longitudinal length of the distribution cable.

2. The distribution cable assembly of claim 1, further comprising a strain-relief component disposed within the distribution interior.

3. The distribution cable assembly of claim 2, wherein the strain-relief component comprises a layer of longitudinally-extending yarns or aramid strands interspersed among and/or surrounding the subunit cables.

4. The distribution cable assembly of claim 1, wherein the distribution cable further comprises a plurality of tether subunits, each tether subunit having a tether jacket surrounding a select number of the plurality of optical fibers and disposed within the subunit interior.

5. The distribution cable assembly of claim 4, wherein each tether subunit comprises two or more optical fibers, the plurality of tether subunits in each cable subunit comprises six or more tether subunits, and wherein the plurality of cable subunits comprises eight or more cable subunits.

6. The distribution cable assembly of claim 1, wherein the plurality of optical fibers comprises optical fibers arranged in optical fiber ribbons.

7. The distribution cable assembly of claim 1, wherein each of the distribution connectors is an MPO connector.

8. The distribution cable assembly of claim 1, wherein each subunit cable has a unique subunit cable length.

9. The distribution cable assembly of claim 1, wherein the subunit jacket comprises an extrudable polymer material that includes one or more materials, additives, and/or components embedded in the polymer material that provides fire resistant characteristics.

10. The distribution cable assembly of claim 9, wherein the subunit jacket comprises a flame-retardant PVC.

11. A communication network comprising:
a plurality of servers, each server being housed in a rack or cabinet;
an edge of rack unit; and
a distribution cable having a distribution end and longitudinal length, the distribution cable comprising:
a distribution jacket defining a distribution interior;
a plurality of subunit cables disposed within the distribution interior, each subunit cable comprising a subunit jacket defining a subunit interior; and
a plurality of optical fibers disposed within the subunit jacket;
a plurality of distribution connectors, each distribution connector attached to one or more of the optical fibers at the distribution end;
a plurality of tap connectors, each tap connector defining a tap end and terminating one or more of the plurality of optical fibers from a respective distribution connector;
wherein each subunit cable routes the one or more of the plurality of optical fibers from one of the plurality of distribution connectors to one of the plurality of tap connectors through a different tap point along the longitudinal length of the distribution cable; and
wherein the distribution connectors connect to the edge of rack unit and each tap connector connects to a respective one of the plurality of servers.

12. A method for configuring and manufacturing pre-engineered cables for a data center network, the method comprising:
providing a configurator module having a processor and a graphical user interface;
uploading or inputting digital infrastructure data to the configurator module, wherein the digital infrastructure data includes server, tray and rack locations;
generating a design for a distribution cable assembly based on the digital infrastructure data that includes drop point locations; and
displaying the design atop the digital infrastructure data on the graphical user interface of the configurator module indicating a route for placement of the distribution cable assembly in the data center network.

13. The method of claim 12, further comprising:
generating a bill of materials and instructions via the configurator module.

14. The method of claim 13, wherein the configurator module generates a cable specification for the distribution cable assembly that includes length, connectorized point locations and connector types.

15. The method of claim 14, further comprising:
transmitting the bill of materials and instructions to a manufacturer to manufacture the distribution cable.

16. The method of claim 12, further comprising:
a database communicatively coupled to the configurator module, the database storing cable family types and design parameters that may be selected and retrieved, the design parameters including cable weight, cable length, optical fiber capacity number, and sub-unit capacity number.

17. The method of claim 12, wherein the drop point locations are automatically determined by the configurator module based on the digital infrastructure data.

18. The method of claim 12, wherein the drop point locations are manually selected by a user and input through the configurator module.

19. The method of claim 12, further comprising a number and location of connectors to be preconfigured into the distribution cable assembly.

20. The method of claim 12, wherein the drop point locations are modifiable by a user.
